(19) United States
(12) Patent Application Publication
(10) Pub. No.: US 2019/0127253 A1
(43) Pub. Date: May 2, 2019

(54) METHOD AND DEVICE FOR TREATING WATER CONDENSED FROM WATER VAPOR CONTAINED IN THE AIR, AND RELATED METHOD AND SYSTEM FOR GENERATING POTABLE WATER

(71) Applicant: LEAUDELAIR S.A., Yverdon-les-Bains (CH)

(72) Inventors: Jean THOMAS, Nice (FR); Simon FERRAND, Yverdon-Les-Bains (CH)

(21) Appl. No.: 15/778,678

(22) PCT Filed: Nov. 24, 2016
(86) PCT No.: PCT/IB2016/057110

§ 371 Date: Aug. 13, 2018

(30) Foreign Application Priority Data
Nov. 24, 2015 (FR) 15/61325

(51) Int. Cl. C02F 9/00; B01D 5/00; E03B 3/28

(52) U.S. Cl. CPC C02F 9/00; C02F 1/001; E03B 3/28; B01D 5/009

(57) ABSTRACT

A device for treating water condensed from water vapor contained in the atmospheric air. A mechanism for adding minerals, via contact of the condensed water with a remineralization reactor containing at least one alkaline earth rock, to produce remineralized water that is in accordance with potable water standards and can thus be sent into a piping system. A system for generating potable water, including mechanisms that are intended for condensing the water vapor contained in the atmospheric air and are combined with such a condensed water treatment device.

### 1. FIELD OF THE INVENTION

The field of the invention is that of the treatment of water obtained by condensing water vapor contained in the air, in particular in order to make it potable and suitable for consumption. In one of its aspects, the invention relates to a system and a method for generating potable water from the atmospheric air, also called D-AWG (for “Drink-Atmospheric Water Generator”).

The water treatment proposed by this invention applies to all types of atmospheric water generators, whether small generators producing about 10 to 30 liters of water per day or larger devices able to produce more than 50,000 liters or even several hundreds of thousands of liters daily.

The water treatment proposed by this invention applies to any type of condensed water resulting from a condensation of water vapor contained in the air, whether produced:
by a condensation using condensation means of human origin: this condensed water can for example result from the operation of an air conditioning system of a room, a housing unit or a building;
   or
by a condensation using condensation means of natural origin: this condensed water can formed of dew, frost, ice, hail, snow, fog or rain water.

According to a specific aspect of the invention, the rain forms condensed water that can be considered as atmospheric water that can be treated by the device and the systems described in this text, and/or according the treatment method according to the invention.

### 2. PRIOR ART AND ITS DISADVANTAGES

Water is a natural resource whose global consumption is quickly increasing, leading to increased shortage risks for the coming years. Water management has thus become a priority on the global level.

The drink-atmospheric water generators, or D-AWGs, which allow producing water from the atmospheric air, represent in this context an interesting complementary alternative to the existing potable water production system, which is based on the extraction and treatment of soft water contained in the rivers or water tables, or on sea-water desalination. In fact, this technology, which falls into a context of sustainable development, allows in particular bringing potable water to areas who lack it. Such drink-atmospheric water generator is described in particular by Rolande V. W., 2001, in “Atmospheric water vapour processor designs for potable water production: a review”, Pergamon, Wat. Res. Vol. 35, No. 1, pp. 1-22.

Numerous research and development works are thus underway, to allow offering to the public devices for generating water from the water vapor contained in the atmospheric air, which produce quality potable water, that is to say which complies with the legal and normative quality requirements for water intended for human consumption.

Such devices, called “cooling surface”, transform the water vapor present in gaseous or liquid form in the air, into liquid water, by condensation on a cold surface, when this water reaches its dew point. They classically include a cooling unit with thermodynamic effect, made of an evaporator, in which water condensates, a compressor, a condenser and an expansion device. After water condensation on the cooled evaporator tubes, the water flows by gravity to be recovered. Such water generation device is for example described in patent documents WO2011063199, U.S. Pat. Nos. 5,203,989, 7,373,787, WO2012123849, WO2012162545, U.S. Pat. No. 7,886,557, or WO 2011117841.

There are also other devices that allow condensing water vapor into water, which are in particular based on the use of silica gel, as described in particular by Rolande V. W., 2001, in “Atmospheric water vapour processor designs for potable water production: a review”, Pergamon, Wat. Res. Vol. 35, No. 1, pp. 1-22.

Various air and water treatments can moreover be provided in these devices in order to improve water quality.

It is, however, important to note that, unlike the water coming from rivers or water tables for example, the water contained in the air contains only very few minerals. Therefore, water produced by such atmospheric water generation devices has a very low mineral content, which poses various problems.

First, this water has a low pH, is very poorly conductive and is not in equilibrium from the calco-carbonic aspect. It can thus show to be aggressive against limestone, concretes and cements, or corrosive against metals. This therefore is a problem when the water produced by the atmospheric water generator is used to supply pipes of households or industrial installations (see in particular the directives on potable water quality issued by the World Health Organization, 4th edition, WHO Library Cataloguing-in-Publication Data. ISBN 978 92 4 154815 1).

In addition, this too soft water does not have a sufficient buffering capacity to avoid sharp pH fluctuations.

Finally, consuming daily water having a too low mineral content is harmful to health: in fact, the World Health Organization has found that consuming and cooking with water containing certain threshold quantities of calcium and magnesium allows in particular to reduce the risks of certain illnesses, such as for example cardiovascular pathologies (“Nutrient minerals in drinking water and the potential health consequences of long-term consumption of demineralized and remineralized and altered mineral content drinking waters”, 2004).

In order to overcome these various disadvantages, certain atmospheric water generators try to remineralize the condensed water by passing it in a cartridge filled with alkaline earth carbonate rock of the calcium carbonate (CaCO₃) type, and which can also contain magnesium carbonate (MgCO₃). This rock is moreover often mixed with calcined limestone, i.e. with alkaline earth oxides of the CaO or MgO type. Such solutions are in particular described in patent documents U.S. Pat. Nos. 8,302,412, 7,886,557, WO 2011117841 or U.S. Pat. No. 7,373,787.

However, this technique generally does not allow producing properly and sufficiently remineralized water to reach the quality references defined by the legal and normative requirements for water intended for human consumption.

In fact, the water produced from water vapor of the air by such atmospheric water generators generally does not contain enough aggressive carbon dioxide to allow dissolving sufficiently alkaline earth carbonate rock, and thus increase sufficiently the minerals content of the water. It is reminded that the aggressive carbon dioxide is defined as the difference between the free CO₂ present in the water and the CO₂ when in equilibrium, i.e. the CO₂ that allows obtaining a water in equilibrium, whose pH is equal to its saturation pH, pH beyond which a precipitation of calcium and bicarbonate ions in the form of carbonate calcium can be noted.

Moreover, the alkaline earth oxides give the water a very high alkalinity at the beginning of their dissolution, which then gradually decreases. Furthermore, their dissolution does not stop at the saturation pH and these oxides continue solubilizing. In the existing atmospheric water generators, the produced water thus frequently shows an exceeding of the quality reference values, especially in the water generators in which the remineralization reactor is integrated in a periodic water recirculation circuit.

Consequently, none of the known atmospheric water generators performs a controlled water remineralization, in which the minerals concentration of the produced water and the values of the associated physicochemical parameters comply with the regulatory quality references, i.e. are sufficient, but lower than the recommended upper limit.

Furthermore, there are also some systems that allow condensing the atmospheric water vapor, but which are a priori not designed to generate potable water. So, the building air conditioning systems (for houses, buildings, offices . . . ), whose function is to cool down the ambient air of the buildings where they are installed, generate condensed water, which unfortunately is not recovered, and most often disposed of. To this day, recovering this condensed water, in particular to transform it into water suitable for human consumption, has not been considered.

So there is a need for an atmospheric water treatment technique that allows overcoming these different disadvantages.

There is in particular a need for such atmospheric water treatment technique that allows producing quality potable water in terms of minerals content, and that in particular complies with the legal and normative requirements relating to the quality of the water intended for human consumption. There is also a need for such technique that allows producing potable water in which the quantity of minerals can be adjusted according to the needs of the consumer.

The objective of the invention is also to provide such water generation technique from atmospheric air that allows producing good quality potable water, in particular substantially free from pollutants or microorganisms.

Another objective of the invention is to provide such technique that allows recovering the water condensed by an air conditioning system of a building in order to make it drinkable, so that it can then be distributed through the piping network of the building and ensure it a certain autonomy. Another objective of the invention is to provide an atmospheric water treatment device implementing such technique, which is relatively inexpensive, but also easy to use and ergonomic.

Yet another objective of the invention is to offer such device that saves energy, allows producing cheap water, and has a high water production yield whatever the ambient conditions. Another objective of the invention is to provide a simple and easy-to-maintain system.

### 3. DESCRIPTION OF THE INVENTION

The invention meets this need by offering a treatment system for water condensed from water vapor contained in the air, which comprises means for adding minerals to said condensed water by contact of said condensed water with a remineralization reactor containing at least one alkaline earth rock,

said means for adding minerals also comprise:
means for controlling a contact time of said condensed water with said remineralization reactor, according to a predetermined quantity of minerals to be added;
means for calculating a quantity of carbon dioxide to be injected in said condensed water, according to said predetermined quantity of minerals to be added;
means for injecting said calculated quantity of carbon dioxide in said condensed water;
   said means for adding minerals producing remineralized water.

Thus, the invention is based on an entirely new and inventive approach of the remineralization of the water obtained by condensation of atmospheric water vapor, in particular to make it drinkable.

In fact, the invention proposes first of all to inject carbon dioxide in the water recovered by condensation, in order to increase the quantity of aggressive CO₂ present in the water, and thus allow better dissolution of the alkaline earth carbonates. Moreover, the invention proposes to control and master this remineralization process, by calculating first the quantity of carbon dioxide to inject, but also the necessary and sufficient contact time between the water and the alkaline earth rock, to achieve a predetermined remineralization rate of the water recovered by condensation.

So, with the knowledge and the control of this minimum contact time, one advantageously avoids the problems due to an insufficient dissolution of the rocks, which prevent from reaching the minerals threshold values and the associated physicochemical parameters recommended by the legal and normative texts relating to the quality of the water intended for human consumption. One also frees oneself from the problems of exceeding the authorized limit values in case of a too long contact time between the water and the reactor. In fact, thanks to the invention, the rock dissolution reaction stops when almost all the aggressive CO₂ has been consumed: hence, the reaction stops around the saturation pH and allows reaching the desired hardness and alkalinity values.

According to a first preferential characteristic of the invention, said control means are able to control at least one of the following parameters:
a flow rate of said condensed water in said remineralization reactor;
a concentration of said carbon dioxide to be injected;
an injection flow rate of said carbon dioxide;
a pressure of said carbon dioxide to be injected.

Thus, by adjusting the CO₂ flow rate and concentration and the water flow in the remineralization reactor, one obtains the necessary contact time between the water and the rock to dissolve the desired quantity of minerals. It is moreover important to have a sufficient CO₂ pressure with respect to the water pressure, in order to ensure a good injection. Furthermore, a variation of the temperature of the CO₂ changes the density of the CO₂ at a given pressure, which modifies its concentration.

According to a particular and preferential aspect of the invention, such device comprises means for a user to select said predetermined quantity of minerals to be added to said condensed water.

So, the consumer can choose the minerals content he wants to obtain for the potable water generated by the atmospheric water generation device of the invention, for example by means of an ergonomic interface of the touch screen type. The calculation means of the device (for example a microcontroller) adjust automatically the quantity of carbon dioxide to be injected and the necessary contact time between the water and the reactor, according to the minerals content desired by the consumer.

The atmospheric water generator of the invention can thus produce various potable waters, more or less remineralized, adapted to the needs and consumption modes of the users.

According to a particular aspect of the invention, the remineralization process can be completed with the injection or the use of one or several reagents belonging to the following list: sodium hydroxide/caustic soda (NaOH), sodium carbonate (Na₂CO₃), sodium bicarbonate (NaHCO₃), quick lime/calcium oxide (CaO), slaked lime/calcium hydroxide (Ca(OH)₂), calcium chloride (CaCl₂), magnesia dolomite (CaCO₃+MgO), magnesium hydroxide-oxide (Mg(OH)₂-MgO), calcium sulphate (CaSO4), sodium chloride (NaCl), sulphuric acid (H₂SO₄), hydrochloric acid (HCl), potassium chloride (KCl), etc. In this case, the treatment device moreover comprises means for adding one or several reagents from the list above.

According to another preferential aspect of the invention, said treatment means of said condensed water comprise means for deionizing said condensed water, producing deionized water. By “deionized water” one means here and in this whole document water from which the ions contained in the original raw condensed water have been partly or entirely removed.

It must be noted that these deionizing means can be operated independently from the means for adding minerals described above, so that the invention also relates to a device for generating atmospheric potable water that comprises deionizing means, but does not comprise means for adding minerals as described above.

Such deionizing means advantageously allow removing from the water collected by condensation a part or most of the compounds and pollutants present in ionic form in the water. In fact, due to their physicochemical properties, the pollutants present in the atmospheric air can be found in the water produced by condensation in the device of the invention. Such pollutants can be organic pollutants, inorganic pollutants such as heavy metals or certain unwanted ions, or also microorganisms of the virus, bacteria, spore . . . type.

According to the embodiments of the invention, said means for deionizing said condensed water comprise at least some of the means belonging to the group including:
a ion exchange resin module;
an aluminosilicate rock of the Zeolite type;
deionizing means, in particular electrical and/or electrochemical deionizing means such as electrodeionization (EDI), electrodialysis (EDR), capacitive deionization (CDI), membrane capacitive deionization (M-CDI);
a reverse osmosis membrane;
a nanofiltration membrane.

According to another preferential aspect of the invention, said treatment means also include means for filtering said condensed water and/or said deionized water, using at least one of the elements belonging to the group including:
a particle filter (cartridge filter, microfiltration membrane, sand);
an activated carbon filter;
an ultrafiltration membrane;
a membrane contactor or a gaseous filtration membrane.

Such filtering means can thus be arranged directly after the evaporator in order to filter the condensed water, or after the deionizing means to filter the deionized water. They advantageously complete the deionizing means and they allow removing certain unwanted particles or compounds from the water in order to increase the quality of the potable water produced. They can also be arranged after the remineralization reactor to filter the remineralized water. The filtration step on activated carbon advantageously allows extracting a significant part of the organic pollutants from the condensed water.

According to another particular and preferential characteristic of the invention, such device also comprises a degassing system such as a stripping device, or a membrane contactor or any other system able to remove at least one Volatile Organic Compound (VOC), unwanted gas or CO₂ from the water.

According to another particular and preferential characteristic of the invention, said means for adding minerals are arranged downstream of said deionizing means, so that said minerals are added to said deionized water to produce said remineralized water.

Thus, the invention advantageously allows remineralizing a weakly ionized water obtained from water vapor contained in the air. The device of the invention thus allows extracting the harmful ions (pollutants) from the condensed water (filtered or not), then adding to the thus deionized water the minerals necessary for a good quality potable water.

According to another preferential characteristic of the invention, when no deionizing means is used, said means for adding minerals are preferably arranged downstream of said filtering means.

In an advantageous embodiment of the invention, such device comprises two dissociated water circulation circuits, that is to say:
a first water circulation circuit comprising a tank for recovering said condensed water, said deionizing means for said condensed water and first water disinfection means, for example by ultraviolet radiation;
a second water circulation circuit comprising said means for adding minerals, a tank for storing said remineralized water and second disinfection means for said remineralized water, for example by ultraviolet radiation.
   The filtering means can be integrated in the first water circulation circuit and/or in the second water circulation circuit, or be distributed between the two water circulation circuits.

In other words, unlike the AWGs of the prior art, which operate in a closed circuit, but with one single water circulation circuit, the atmospheric water generator of the invention comprises two separate recirculation circuits:
the first is a closed circuit including the means for deionizing the (possibly filtered) condensed water;
the second is a closed circuit including the means for remineralizing the (possibly filtered) water;

Such recirculation circuits advantageously allow circulating the water through the atmospheric potable water generator in order to avoid water stagnation, which would promote bacterial development and a possible biofilm development. The use of two distinct water circulation circuits advantageously allows separating the deionized water from the remineralized water, and thus offering in a same atmospheric water generator deionizing means on the one hand and remineralizing means on the other hand, which can be operated jointly in a cost-effective manner. One understands well, in fact, that the operation of a single water circulation circuit comprising deionizing means on the one hand and means for adding minerals on the other hand would be unrational and at least uneconomical, since, at every water circulation in the single recirculation circuit, one would remove ions from the water, and directly after add ions beneficial for the water.

According to a particular and preferential aspect of the invention, such device then comprises means for the periodic activation of the circulation of the water in each of said first and second circuit.

According to a particular and preferential aspect of the invention, such device also comprises means for partial or total oxidation of at least one chemical compound present in said condensed water and/or in said filtered water and/or in said deionized water and/or in said remineralized water.

Such partial or total oxidation means belong to the group including:
chlorination oxidation means;
means for oxidation by the action of chlorine dioxide;
means for oxidation by the action of ozone;
means for oxidation by ultraviolet radiation (for example under the action of an ultraviolet lamp with a wavelength in the order of 185 nm)
means for implementing an advanced oxidation process (AOP).

Such chemical oxidation means allow oxidizing organic or inorganic compounds present in the water.

According to an embodiment, such device also comprises means for disinfecting said condensed water and/or said filtered water and/or said deionized water and/or said remineralized water, implementing at least one of the elements belonging to the group including:
an ultraviolet lamp;
Chlorine;
Chlorine dioxide;
Ozone.

According to an embodiment, such disinfection means comprise at least one residual disinfectant able to ensure in time water quality at microbiological level during the distribution of this water in a piping network.

The means for disinfection and total or partial oxidation can of course be combined, so that oxidation and disinfection are performed jointly (and in particular during a same step).

The invention also relates to a treatment method for water condensed from water vapor contained in the air, which comprises a step of adding minerals to said condensed water by contact of said condensed water with a remineralization reactor containing at least one alkaline earth rock, Such a minerals adding step implements sub-steps:
control of a contact time of said condensed water with said remineralization reactor, according to a predetermined quantity of minerals to be added;
calculation of a quantity of carbon dioxide to be injected in said condensed water, according to said predetermined quantity of minerals to be added;
injection of said calculated quantity of carbon dioxide in said condensed water;
   said step of adding minerals to said condensed water producing remineralized water.

According to an embodiment of the treatment method according to the invention, said step of adding minerals moreover implements a sub-step for calculating the minimum contact time to achieve a predetermined remineralization rate of the water collected by condensation. So, thanks to the means for controlling the contact time, it is also possible to check whether this minimum contact time between the water and the alkaline earth rock has been reached.

All characteristics and advantages listed and described above in relation to the condensed water treatment device also apply to the condensed water treatment method according to the invention.

The invention also relates to a system for the generation of potable water from atmospheric air, comprising means for condensing a water vapor contained in the air, able to produce condensed water, characterized in that it comprises a treatment device for said condensed water as described previously.

In a particular embodiment of the invention, such system comprises means for treating the atmospheric air arranged upstream of said condensation means.

Treating the air before condensing the water vapor prevents the presence of certain pollutants in the condensed water. Now, certain compounds are very difficult to filter after their dissolution in water, it is therefore particularly advantageous to filter them beforehand.

Such means for treating the atmospheric air advantageously comprise at least some of the means belonging to the group including:
an air pre-filter able to remove coarse particles contained in the atmospheric air;
a particle air filter able to remove fine particles contained in the atmospheric air;
a photocatalytic air filter;
a disinfection by UV ultraviolet radiation.

According to another preferential characteristic of the invention, such system comprises at least one sensor delivering information about the quality of the atmospheric air, and means for stopping said potable water generation system when said information about the quality of the air is lower than a predetermined threshold.

According to a particular aspect of the invention, such system allows collecting and treating the water condensed by equipment external to the system. Notably, in an embodiment, the means for condensing water vapor contained in the air are part of an air conditioning device of a whole or of a part of a building.

In fact, the water treatment system described in the invention can for example be connected to an external cooling unit that ensures the air conditioning of a building, in order to produce potable water from water naturally condensed during the air cooling process. According to an embodiment, the water produced according to the invention has the required characteristics to be distributed through the piping network of the building.

According to a specific aspect of the invention, such system is located upstream of a bottling unit or of a potable water distribution network.

The invention also relates to a water treatment system using condensed water from natural condensation, such as for example dew.

### 4. LIST OF THE DRAWINGS

Further goals, characteristics and advantages of the invention will be better revealed in the following description given as a simple illustrative, non limiting example, in reference to the drawings, in which:

FIG. 1 presents in schematic form an embodiment of an atmospheric water generator comprising a water treatment device according to a first embodiment of the invention;

FIG. 2 illustrates in form of a diagram, the water circulation circuits of the atmospheric water generator of FIG. 1

FIG. 3 presents a P&ID (piping and instrumentation diagram) of a water treatment device according to a second embodiment of the invention;

FIG. 4 illustrates a treatment method for condensed water implementing the device of FIG. 3, with possible variants, and

FIGS. 5 and 6 illustrate other treatment methods for condensed water according to the invention.

### 5. DETAILED DESCRIPTION OF EMBODIMENTS OF THE INVENTION

The general principle of the invention is based on a mastered and controlled remineralization of the water produced from the water vapor contained in the air.

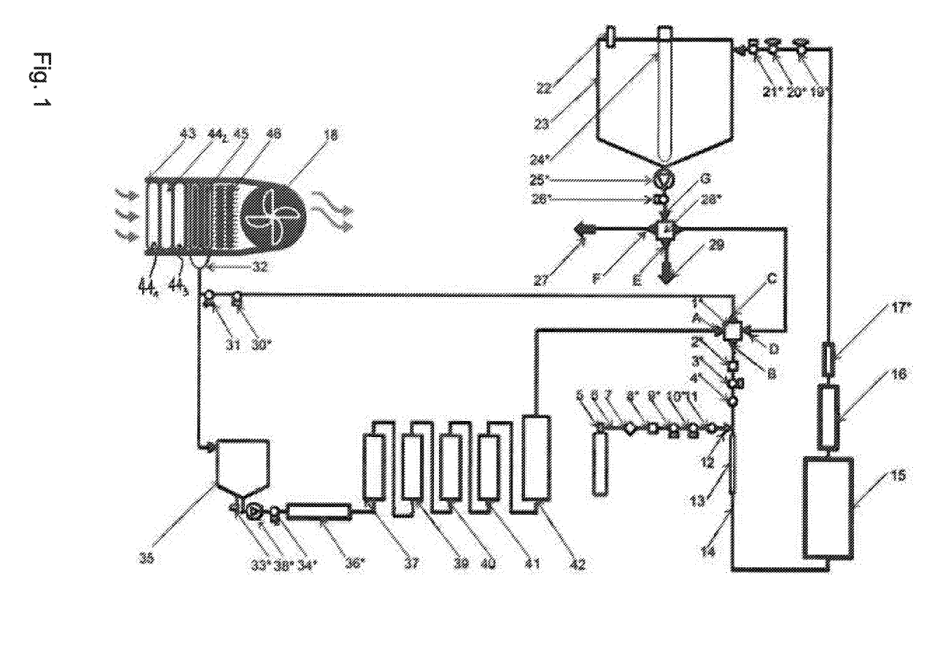

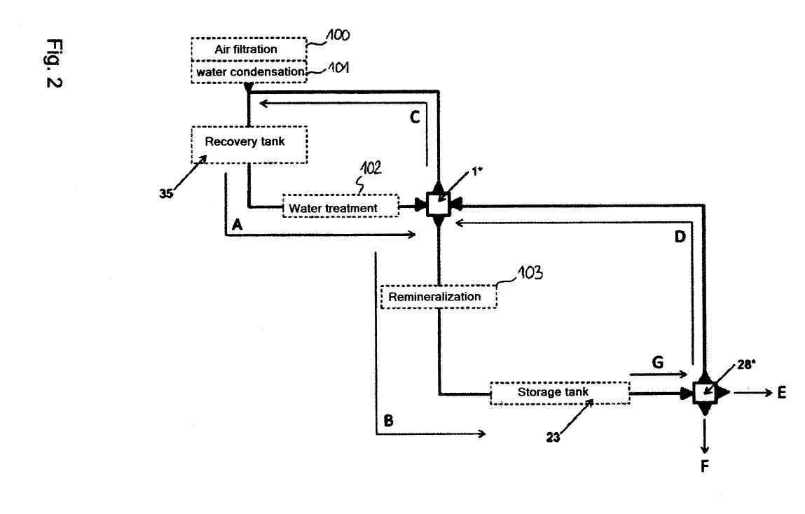

The following section of this document presents, in reference to FIGS. 1 and 2, the treatment technique of the condensed water of the invention in the specific application context of an atmospheric potable water generator. The specific water treatment means described below for FIGS. 1 and 2 can of course be implemented independently from the water vapor condensation means or, as a variant (case of FIGS. 1 and 2), integrated with these water vapor condensation means in an atmospheric potable water generation system. Therefore, this second variant will be described more specifically below.

An embodiment of an atmospheric potable water generator according to the invention is presented in reference to FIGS. 1 and 2. Such device allows generating potable water from the water vapor contained in the air.

As illustrated in a summarized way in the form of functional blocks in FIG. 2, such device comprises:
a functional module 100 (optional) for filtering the ambient air;
a functional module 101 for condensing the water vapor contained in this ambient air.

Moreover, the water thus condensed undergoes a closed circuit treatment comprising, in this first embodiment, a water treatment 102 implementing in particular a deionizing treatment and a remineralizing treatment 103. These two treatment systems referenced 102 and 103 are each integrated in a distinct recirculation circuit, that is to say the recirculation circuit including the water circulation paths referenced A and C for water treatment 102, and the recirculation circuit including the water circulation paths referenced B, G and D for water remineralization treatment 103.

It must be noted that, in a variant, the atmospheric potable water generator of the invention can implement only remineralizing treatment 103, in a closed circuit, without deionizing treatment. As an alternative, the atmospheric water generator of the invention can also implement only water treatment 102, in a closed circuit, without remineralizing treatment.

As it will be seen more in detail later referring to FIG. 1, water treatment 102 allows filtering most of the organic and inorganic compounds present in the form of pollutants in the water coming from functional condensation module 101, and destroying 99% of the microorganisms. Remineralizing treatment 103 allows efficient and controlled adding of calcium, magnesium and hydrogen carbonate/carbonate ions, and a disinfection of 99.99% of the microorganisms. In an embodiment variant without water treatment 102, this remineralization 103 can be performed directly on the water coming from condensation module 101 or stored in recovery tank 35.

These different functional modules will now be described more in detail in a particular embodiment illustrated in FIG. 1.

The atmospheric water generator of the invention comprises a certain number of electrical or electronic components, which are identified in FIG. 1 by an asterisk located near to their numerical reference.

A microcontroller, which has not been represented in FIG. 1, controls all these components. It is for example connected with an interface with a touch screen (not represented), which allows the user to monitor the operation of the atmospheric potable water generation device and to interact with it. In particular, this interface can allow the user to select various operating modes of the device.

### 5.1 Filtration of the Air

This section presents more in detail functional module 100 for ambient air filtration in reference to FIG. 1. Such module is optional, but it is presented below within the framework of a specific embodiment of the invention.

Most of the AWGs of the prior art, which most often are domestic appliances (used in indoor atmosphere), filter the atmospheric air by means of a particle pre-filter, which allows retaining and extracting only the biggest particles contained in the air.

Now, certain volatile organic pollutants (VOC for “Volatile Organic Compounds”) can see their concentration multiplied by 5 or 10, or even 100, in certain indoor atmospheres, where they are permanently present. When they are solubilized in water, some of these pollutants then pass all classical water filtration barriers.

The atmospheric water generator of the invention implements, in a particular embodiment, a filtration or degradation of these chemical pollutants by treating the air prior to the condensation of the water by functional module referenced 101.

To this purpose, when the atmospheric water generator is in potable water production mode, the air drawn in by a variable speed fan 18 enters an air duct referenced 43. It first passes through an air pre-filter 44₁, which allows filtering the coarse particles contained in the atmospheric air. This pre-filter 44₁ can for example be placed in a removable frame that can easily be removed from the D-AWG, to be cleaned according to its nature and composition. This pre-filter 44₁ of the G1 to G4 type (standard EN 779) is followed by a filter 44₂, which allows filtering finer particles suspended in the ambient air. Pre-filter 44₁ and particle filter 44₂ are followed by a photocatalytic oxidation air filter 44₃.

Such photocatalytic oxidation air filter 44₃ implements an advanced oxidation process, wherein the chemical pollutants sorb on a catalytic media including in particular a semi-conductor such as titanium dioxide (TiO₂). Lamps emit an ultraviolet (UV) radiation on the titanium dioxide TiO₂, which transforms water and oxygen molecules into hydroxyl free radicals. These radicals are very reactive and have the particularity of being non-selective. They degrade most of the pollutants of the gaseous phase. This technology allows cleaning up the air before it reaches the evaporator, which allows obtaining better quality condensed water. In addition, used in a domestic atmospheric water generator, it allows purifying the atmosphere inside a home.

One will note that air filtration module 100 can, in an embodiment variant, include only one or two of the three filters referenced 44₁ to 44₃ described above. In an embodiment, one or several air quality sensors (not represented on FIG. 1) are located in air duct 43 before air filtering module 100 to detect the presence in the air of certain potentially toxic substances, such as carbon dioxide, nitrogen oxide, benzene, smoke, etc. Such sensors are connected to the microcontroller of the atmospheric water generator, which can issue an alert to the user, and automatically stop the production of water by stopping fan 18 and the compressor.

### 5.2 Water Vapor Condensation

The water vapor condensation module referenced 101 is now presented. This is a cooling unit with thermodynamic effect, which is used in this embodiment for cooling the cold surface that allows condensing the water vapor of the air into liquid water.

In a variant, this water vapor condensation module referenced 101 can be a part of an air-conditioning system of a building, which produces naturally condensed water during the ambient air cooling phase. This condensed water can thus be recovered by treatment according to the technique of the invention in order to make it potable.

The air filtered by air filtration module referenced 100 is then drawn in by variable speed fan 18 through evaporator 45 and condenser 46 and returned outside the D-AWG through one or several ducts. The water vapor contained in the air condensates on evaporator 45 made of tubes out of food-grade stainless steel or copper covered with food-grade plastic. According to a variant, heat exchange fins are present on the tubes. To ensure good recovery of the condensed water, a small chute 32 with a slight slope is placed at the base of evaporator 45. The water passes through a pipe to reach recovery tank 35. A check valve 31 prevents the water from flowing back into recirculation pipe of path C, coming from solenoid valve 1.

One will note that, in FIG. 1, the fan has been placed downstream of air filtration module 100. As a variant, it can also be placed upstream of this air filtration module 100 in the air flow direction.

Water production is controlled by the microcontroller, and several production modes can be offered and selected by the consumer through the man/machine interface of the atmospheric water generator of the invention.

Moreover, the microcontroller (not represented) of the D-AWG of the invention controls the powering of the compressor and the speed of fan 18 according to the psychometric diagram of the humid air (that is to say of the water mass available in the air), to the water volumes in the recovery tank referenced 35 and/or in the storage tank referenced 23.

In a particular embodiment, a temperature sensor and a humidity sensor located at the air inlet allow calculating the favorable dew point for the condensation. According to this calculation, the speed of the refrigerant fluid in the tubes is accelerated or slowed down to achieve the good temperature on evaporator 45. A surface temperature sensor on evaporator 45 allows monitoring this temperature. It also allows, in case of frost, to initiate defrosting (slow down or stop of the refrigerant gas). In an embodiment, a relative humidity sensor at the air outlet allows measuring the humidity of the dry air. This value and the air inlet humidity value allow calculating the condensation efficiency. According to this efficiency, the speed of fan 18 and the evaporator surface temperature can be modified.

In an embodiment, a pressure sensor measures the gas pressure at the condenser outlet. This allows calculating the temperature of the refrigerant gas thanks to the physicochemical properties of the gas.

In an embodiment, the temperature of the condenser can be stabilized by means of one or several fans connected to a frequency converter. These fans are arranged on the condenser and allow for example to cool it more efficiently when the temperature of the refrigerant gas is too high. This results in the measurement of a higher pressure by the pressure sensor mentioned above. In this configuration, one or several fans replace fan 18 to allow sending the atmospheric air through evaporator 45 (and optionally condenser 46). They are located upstream or downstream of the evaporator.

According to the option selected by the user, the microcontroller adapts, with frequency converters, the speed of fan 18 (and of the fan(s) of the condenser, if any) and the power of the compressor that controls the refrigerant fluid/gas flow rate.

in a particular embodiment of the invention, a “lotus effect” food-grade paint is applied to the tubes of evaporator 45. This is a biomimetic paint that uses the hyper-hydrophobicity and self-cleaning properties of the lotus leaves. It allows foreign elements to slide on the surface of the evaporator 45 without adhering to it. This paint allows the water to slide faster on the condensation tubes while preventing bacteria or micro dusts from sticking on them. Bacterial growth on the tubes is reduced, which also reduces regular cleaning constraints. The water is therefore less exposed to pollution, since its contact time with the air drawn in is reduced.

Alternatively, a hyper-hydrophilic self-cleaning paint is applied to the evaporator tubes. It allows the water to flow faster on the evaporator tubes, thus reducing the contact between the water and the pollutants of the air.

So, the use of these particular paints advantageously reduces the contact time between the water and evaporator 45, and therefore the risks of pollution of the generated water.

In a particular operating mode of the atmospheric water generator of the invention, water extraction is realized by alternating a water freezing phase and a water unfreezing phase on evaporator 45. The water vapor of the air then solidifies directly on the tubes when the temperature of the refrigerant fluid is lower than 0° C. After some time, the tubes of evaporator 45 are heated up and make the ice melt. This principle allows working with a negative dew point to manage to collect the humidity of the air at temperatures and humidities lower than those usually used. Water production efficiency is improved for adverse conditions.

One can also consider arranging, between air filtration module 100 and evaporator 45, a small meshed resistor that covers the surface of aspiration duct 43. Such resistor allows increasing the temperature of the air drawn in and therefore condensing the water at a higher dew point, and thus at lower ambient air temperatures. This improves water production efficiency.

A classical cooling unit with thermodynamic effect is made of an evaporator 45, an electrical compressor, a condenser 46 and an expansion device. Tubes filled with a refrigerant gas/liquid run around the circuit.

Its theoretical operation is as follows: the hot and humid air that is drawn in or projected by fan 18 then passes through evaporator 45, which contains a cold low-pressure gas in liquid/vapor form. The air that cools down on evaporator 45 leads to the condensation of the water vapor it contains and heats up the refrigerant gas by heat exchange. The gas heated up is then compressed in the compressor, which increases its pressure and thus its temperature. The cold dry air that passed through evaporator 45 passes through condenser 46, which it leaves in the form of hot dry air. The refrigerant gas in the form of vapor that exits the compressor cools down in condenser 46 by heat exchange on contact with the cold dry air and liquefies. The refrigerant liquid then passes in the expansion device, where its pressure sharply decreases. It then cools down again and returns to the liquid state before it returns in the evaporator for a new cycle. This sharp pressure loss induces energy absorption and thus the refrigeration of the evaporator.

The expansion device can be thermostatic, electronic or capillary. One can also optionally arrange a dryer between condenser 46 and the expansion device, to dehydrate the fluid condensed by condenser 46.

Likewise, one or two pressure switches can optionally and independently be arranged before and after the compressor, to measure respectively the fluid pressure drops and increases in the refrigerant fluid circuit. Optionally, a bottle of refrigerant gas can be placed after the condenser. It allows varying the quantity of gas in the refrigerating circuit.

As an optional variant, one can also provide by-passes of the refrigerant circuit by means of solenoid valves to cool down or heat up cold or hot water tanks and/or supply an ice cubes production appliance.

The water thus produced by condensing the water vapor of the air is collected in a collector 32 whose totally flat surface has a slight slope to let this water flow by gravity in the water pipe of path C up to a recovery tank referenced 35.

The bottom of tank 35 has a conical or spherical shape to allow complete draining, thanks to the outlet located in its center. Its inner surface is preferably smooth.

The water level in recovery tank 35 can be measured by a diaphragm pressure sensor 33 located on the side of the outlet of the tank. Water level measurement is performed thanks to the pressure exerted by the water on sensor 33. In a variant, a level transmitter is used.

### 5.3 Treatment of the Water Obtained by Condensation

The treatment performed on the water thus recovered in the recovery tank referenced 35 in the water treatment module referenced 102 is now presented more in detail.

The water recovered in recovery tank 35 is sucked in by a pump 38 through a valve 34 towards an Ultra Violet disinfection reactor 36, operating for example at a disinfecting wavelength of 254 nm. In a particular embodiment, pump 38 is located right after recovery tank 35. As a variant, the UV-C sterilization reactor 36 is replaced by a UV-C lamp and its quartz cover placed at the center of recovery tank 35.

The UV-C energy produced by sterilization reactor 36 or the UV-C lamp deteriorates the genetic material (DNA) of the microorganisms contained in the water, which reduces their ability to reproduce or cause infections One preferably delivers an UV-C energy dose comprised between 60 and 120 mJ/cm².

The water then passes through a particle filter referenced 37, adapted for example for a 0.5 μm filtration, then through one or several activated carbon filters or reactors referenced 39. These filters 39 can be classical activated carbon filters or specific activated carbon filters for Volatile Organic Compounds/heavy metals. In another embodiment, another particle filter can be placed after the activated carbon filter to prevent the release of fines in the network by the activated carbon.

It must be noted that, as a variant, the UV-C sterilization reactor 36 can be placed after the activated carbon filter referenced 39 or after the particle filter referenced 37.

In addition to this filtering, it is also desirable to perform a ionic filtration of the water to extract the pollutants in ionic form. In the AWGs of the prior art, such ionic filtration is generally performed by means of a reverse osmosis membrane, which allows separating the microorganisms, the ions and the organic compounds of the water. After this filtration, the permeate is the purified water that has been filtered, and the concentrate is the water that contains the filtered microorganisms, ions and organic compounds. In the AWGs of the prior art (see in particular patent document U.S. Pat. No. 8,302,412), the concentrate is returned to the collected raw water to be continuously re-filtered. In the long term, this can lead to growing increase of the pollutants concentration in the raw water (as described for example in patent document WO2011117841A1). A deterioration of the filtration quality of the membrane can then occur, due to a compound concentration polarization, followed by a clogging on the membrane and/or a perforation of the latter.

In order to solve this drawback, it is proposed, according to the invention, to subject the water to a deionizing treatment, which can be implemented according to various embodiment variants.

A first embodiment variant is based on the use of one or several ion exchange resins, which can retain, according to their nature, their selectivity factor and their separation factor, all or a part of the ions contained in the water.

Such ion exchange resins can, among others, retain trace metals, unwanted ions such as ammonium, nitrite, nitrate, radionuclides . . . One can thus choose to use:
a SAC[H] (strongly acid cation exchange resin with H⁺ exchange) resin cartridge referenced 41 and a SBA[OH] (strongly basic anions exchange resin with OH⁻ exchange) resin cartridge referenced 40; in an embodiment, the SBA[OH] resin cartridge is located before SAC[H], or
a SAC[H] (strongly acid cation exchange resin with H⁺ exchange) resin cartridge or a SAC[Na] (strongly acid cation exchange resin with Na⁺ exchange) resin cartridge and a SBA[Cl] (strongly basic anions exchange resin with Cl⁻ exchange) resin cartridge; or
a Mix SAC[H]/SBA[OH] or SAC[H]/SBA[Cl] or SAC[Na]/SBA[Cl] resin cartridge; or
a WAC (weakly acid cation exchange resin) resin cartridge; or
a WAC (weakly acid cation exchange resin) resin cartridge and or a WBA (weakly basic anion exchange resin) resin cartridge

One can also use a specific resin to eliminate certain radionuclides, as a replacement for or an addition to the resins described above. One can also, still as a replacement for or an addition to the other ion-exchange resins, use a specific resin to reduce the TOC (Total Organic Carbon).

In an embodiment, a unit for regenerating these resins can be added to the system. For example, a SIATA or Fleck valve allows starting the regeneration manually or automatically, for example according to the conductivity of the water at the outlet of the ion exchange unit, to the water volume flown through the unit or to the operating time.

Moreover, in the embodiment illustrated in FIG. 1, these ion exchange resins referenced 40 and 41 are located upstream of a filtration membrane referenced 42 that will be described more in detail later. As an alternative, the ion exchange resins 40 and 41 can also be located downstream of this filtration membrane referenced 42.

In a second embodiment, the ion exchange resin(s) is/are replaced by an aluminosilicate rock cartridge of the zeolite type.

In a third embodiment variant, the water undergoes an electrical purification process involving a combination of ion exchange resins and ion-selective membranes, called electrodeionization (EDI). This approach prevents water quality drop resulting from the gradual exhaustion of the resin cartridges, as well as the cartridge replacement costs. As for the ion exchange resins referenced 40 and 41, such EDI module can be located before of after a filtration membrane referenced 42.

In a fourth embodiment, a reverse osmosis or nanofiltration membrane allows deionization.

This filtration membrane referenced 42 is now described more in detail. It must be noted that this filtration membrane can perform alone the water deionizing treatment, in certain embodiments of the invention, or complement the deionizing treatment performed by the ion exchange resins, the zeolite or the EDI.

In the example of FIG. 1, the membrane referenced 42 is an ultrafiltration membrane crossed by the water before reaching the solenoid valve referenced 1. Such ultrafiltration membrane has for examples pores of a diameter between 1 and 100 nm. It lets the ions pass, but it retains the high molecular weight molecules.

As an alternative, such filtration membrane 42 is a membrane of the Reverse Osmosis type or a nanofiltration membrane: in this case, the filtered water flows in the solenoid valve referenced 1 and the residual concentrate passes through a pressure reducing valve to enter the recirculation pipe of path C, before returning to recovery tank referenced 35.

In another embodiment, the water of recovery tank 35 is drained periodically after a certain time, or thanks to a conductivity transmitter (located after pump 38 and connected to the microcontroller) when a threshold conductivity value is exceeded.

In a certain embodiment, the residual concentrate is directly disposed of in the sewer.

The nanofiltration membrane allows separating components with a size in solution close to the nanometer. The monovalent ionized salts and the non-ionized organic compounds with molecular weights less than 200-250 g/mol (Dalton) are not retained. The reverse osmosis membrane rejects constituents whose molecular weight exceeds 50-250 g/mol (Dalton): the monovalent ions and a portion of the uncharged compounds.

After having passed through the filtration membrane referenced 42, the treated water reaches the solenoid valve referenced 1, which is preferably a four-way valve with three flow models. There may also be several solenoid valves that allow achieving four ways with three flow models.

Moreover, one places on water circulation paths A and C of FIG. 1 two flow meters referenced 34 and 30, which are connected to the microcontroller and allow calculating the volume of “raw” (untreated) water that passed through the water treatment device of path A, in order to calculate the remaining lifetime of each of the filters arranged on this path. The volume of water coming from the recirculation of the solenoid valve referenced 1 in “demineralized recirculation” mode (see below) of path C, which already passed through the water treatment device of path A, is deducted.

A “Stripping” system can be implemented in addition to the water treatment referenced 102. “Gas stripping” is a process that allows mass transfer of a gas from the liquid phase to the gaseous phase. Transfer is performed by putting the liquid containing the gas to be removed in contact with air that does not contain this gas initially. The elimination of gas dissolved in water by gas stripping is in particular used for eliminating ammoniac (NH₃), odorous gases and volatile organic compounds (VOCs). In an embodiment, gas stripping is performed in recovery tank 35 and air is injected by means of a venturi injector. A water pump draws the water of recovery tank 35 and sends it to a venturi injector. Optionally an air pump sucks in ambient air and sends it to the venturi injector. In an embodiment, the air sucked in is filtered by an air filter. The air drawn by suction (enhanced or not by the air pump) in the venturi injector is injected in the water in the form of small bubbles. This bubbled water is sent to the bottom of recovery tank 35 so that the bubbles evenly cover the whole of the water volume of the tank (for example by means of a system of perforated pipes that cover homogeneously the surface of recovery tank 35). The air bubbles rise along the water column of tank 35 until reaching the atmosphere. The gases present in the water are extracted by the water bubbles. In another embodiment, gas stripping is performed in recovery tank 35 and the air is injected thanks to an air pump (with or without air filter) that sends air in one or several air diffusers (out of ceramic for example) that evenly diffuse the air bubbles in the water column of recovery tank 35.

In addition to the water treatment referenced 102 described above, one may implement a chemical oxidation process with ozone to degrade totally or partly the chemical compounds. All components in contact with ozone are suitable for such use. An ozonator is used to generate ozone that is then injected in the water treatment system.

The ozone can be injected in a specific reactor intended for this purpose or in the recovery tank referenced 35. This ozonation treatment can be followed by an activated biological carbon treatment, which reduces the fraction formed by BDOC (biodegradable dissolved organic carbon).

In addition to the water treatment referenced 102, one may implement an advanced oxidation process that produces hydroxyl radicals (for example with the photolysis of the ozone by Ultra Violet).

Another chemical oxidation process can be used in the water treatment referenced 102 or 103. One can for example use Chlorination or Chlorine dioxide. A method for producing chlorine could be achieved for example by electrolysis of a salt solution. The free chlorine produced is continuously measured by an electrochemical sensor.

Another chemical oxidation process can be used in the water treatment referenced 102 or 103. One can for example use an ultraviolet radiation treatment, in particular with a wavelength equal to or of the order of 185 nm.

For these industrial D-AWGs, barometers or pressure sensors are arranged between every installed filter/reactor. They will monitor a possible pressure drop indicating an obstruction in the filter/reactor. At least one disinfection is provided on the network, with an UV system or a residual disinfectant.

The oxidation process and the disinfection process using both a residual disinfectant can be combined in one single step. One can for example use the Chlorination. The injected concentration of such oxidant must however be controlled, so that the oxidation and disinfection steps achieve their oxidation and disinfection objectives without exceeding the concentrations of by-products induced by such processes admitted by the potable water standards.

### 5.4 Remineralization of the Water

The remineralization referenced 103 implemented in the embodiment of FIG. 2 downstream of the solenoid valve referenced 1 on water circulation path B of the D-AWG according to the invention is now described more in detail.

Such remineralization 103 is based on a recarbonation by injection of carbon dioxide (CO₂) and a neutralization by filtration on calcium carbonate (CaCO₃) alkaline earth rock, optionally mixed with magnesium carbonate (MgCO₃). The calcium/magnesium carbonates react with the free aggressive CO₂ of the water, which leads to a simultaneous increase of the TH (Hydrotimetric Title or total hardness) and of the CAT (Complete Alkalimetric Title or alkalinity). Thus, filtration on limestone allows neutralizing the water, but also remineralizing it partially. By increasing the CO₂ concentration of the condensed water, filtration allows a more significant increase of the alkalinity and therefore allows a real remineralization of the water.

The free CO₂ decomposes in two parts in the case of an aggressive water: the balancing CO₂, which is the free CO₂ concentration necessary for obtaining the calco-carbonic equilibrium, and the aggressive CO₂, which represents the excess of free CO₂ with respect to the balancing CO₂. The free CO₂ is in hydrated form or not.

The following reactions govern this process:

CO_{2(dissolved)}+H₂O=H₂CO₃

[H₂CO₃]*+H₂O+CaCO₃₍ₛ₎=Ca(HCO₃)₂

[H₂CO3]*+H₂O+MgCO₃₍ₛ₎=Mg(HCO₃)₂

With

Ca(HCO₃)₂=Ca²⁺+2HCO₃⁻

Mg(HCO₃)₂=Mg²⁺+2HCO₃⁻

Theoretically, to increase the mineralization by 1° f, the following must be used: 4.4 mg/L CO₂ and 10 mg/L CaCO₃.

The contact time between the aggressive CO₂ and the calcium/magnesium carbonate rock necessary for achieving the calco-carbonic equilibrium depends, among others, on the characteristics of the raw water (aggressive CO₂, free CO₂, pH, CAT, TH, ionic strength, etc.), on the temperature of the water, on the quantity of filer medium, on its physical characteristics (porosity, grain size, density, etc.) and on the characteristics of the reactor (diameter, minimum rock height, etc.).

The water obtained by the condensation of the water vapor of the air has generally very low CAT and TH, contains only little aggressive CO₂ and its pH is slightly acid. Moreover, in the embodiment described with respect to FIGS. 1 and 2, which implements partial or total deionization techniques, this water is deionized (CAT and TH even lower). Therefore the variation of these parameters can be neglected in view of the high CAT concentrations desired and of the CO₂ to be injected, which are therefore set at fixed values. The injected CO₂ will transformer into aggressive CO₂ to react with the rock. The material used can be Maërl-type marine limestone or marble-type terrestrial limestone. 1.6 to 2.4 g of Maërl are consumed for 1 g of aggressive CO₂, against 2.3 g of marble.

The necessary contact time between the water and the limestone rock is determined taking into account the dimensions of the reactor and the water flow rate. For example, the lower the flow rate and the larger the diameter of the reactor, the longer the contact time. For a contact time of the order of 20 minutes and a reactor of a diameter of approximately 11.5 cm with a minimum calcite height of 25 cm, a flow rate of approximately 8 L/h must be adjusted.

More generally, the microcontroller calculates the CO₂ concentration necessary to dissolve the rock in order to obtain the desired quantity of minerals in the water. The CO₂ flow rate is adjusted. The microcontroller then defines the contact time between the aggressive CO₂ and the rock for these conditions and the dissolution kinetics of the rock, then the water flow rate is adjusted according to the dimensions of the remineralization reactor.

An embodiment example of this remineralization treatment described above is now described more in detail in its general principle, referring to FIG. 1.

A pump referenced 38 sends the water from water treatment device 102 of path A to solenoid valve 1, which directs it towards remineralizing device 103 of path B.

According to a quantity of minerals selected by the user, the microcontroller defines the water flow rate by means of the flow rate controller/proportional solenoid valve referenced 2 and of the flow meter referenced 3. It must be noted that, as a variant, the flow meter referenced 3 can be located before the solenoid valve referenced 2. The solenoid valve referenced 1 then adjusts the water flow rate for path B based on the data collected by the flow meter referenced 3 and sends the excess water in path C

The pressure reducer/pressure regulator referenced 7 stabilizes the outlet pressure of the CO₂ that exits the CO₂ bottle 5 (or a CO₂ tank) through the pipe referenced 6, whatever the pressure in the bottle. A CO₂ filter can be placed on pipe 6.

The proportional solenoid valve/flow rate controller 8 then opens to allow the CO₂ exiting bottle 5. Another possibility would be to place an “All or Nothing” solenoid valve before or after the flow rate controller referenced 8 to release the CO₂ of the tank.

The CO₂ concentration and flow rate necessary for dissolving the selected quantity of minerals, for the already defined water flow rate, are calculated by the microcontroller and regulated by the proportional solenoid valve/flow rate controller referenced 8 and the flow meter referenced 9 (which can be placed before or after the flow rate controller referenced 8). To define the proper gas flow rate, the microcontroller performs a volume flow rate conversion, depending on the density of the CO₂ which is related to the pressure and to the temperature of the mass flow rate. A “mass flow controller” for gas can replace proportional solenoid valve/flow rate controller 8 and flow meter 9.

In order to optimize the CO₂ flow rate calculation, a temperature sensor referenced 10 can be arranged in the gas pipe referenced 6: in fact, a variation of the temperature of the gaseous CO₂ modifies the density of the CO₂ at a given pressure, which modifies its concentration.

Likewise, it the pressure measured by the pressure sensor referenced 4 in the water pipe varies, the CO₂ pressure regulator referenced 7 will for example allow increasing the CO₂ outlet pressure (automatically or manually).

The gaseous CO₂, after being released by the solenoid valve referenced 8, continues advancing by its pressure in the pipe referenced 6, to pass the water-gas check valve referenced 11. This valve prevents the water from entering the gas pipe when no CO₂ is supplied.

The gaseous CO₂ is finally injected in the water by the injector referenced 12. Depending on the size of the D-AWG and the quantity of water treated, a venturi injector is used directly or in by-pass. A pressure sensor can moreover be added before the check valve referenced 11.

In order to facilitate the dissolution of the CO₂ injected in the water, before the water reaches remineralization reactor 15, one can provide to lengthen the pipe referenced 14 leading the water to this reactor. A gas/water mixer (“in-line static mixer”) 13 can also be provided.

Likewise, one will note the possibility to insert on water circulation path B, a pH meter and/or a conductometer in order to characterize the water to be remineralized and thus to adjust best the water flow rate in remineralization reactor 15 according to the desired calco-carbonic parameters.

As an alternative, the system can comprise no sensor, allow no adjustment of the CO₂ concentration and flow rate and of the water flow rate, and be then “oversized” to correspond to the maximum CO₂ capacity and flow rate, and to the worst water properties.

The water then enters the remineralization reactor referenced 15, which contains calcium and/or magnesium carbonate in the form of gravel. In this embodiment, such reactor 15 has the shape of a cylinder.

In an advantageous embodiment, the water enters remineralization reactor 15 from the bottom and exits from the top, which allows reducing the washings and the creation of preferential paths. Two buffer filters are located at the two ends in the cylinder, between the limestone rock and the inlet/outlet, to prevent as many fines (small dissolved limestone particles) as possible from contaminating the network.

The dimensioning principle of a reactor is known by the persons skilled in the art: the diameter of the reactor, the actual percolation speed, the mass of the limestone rock in the reactor, the time between two refills, are calculated from the water-limestone rock contact time, the peak flow rate to be percolated, the height of the cartridge/reactor, the maximum limestone rock filling height in the reactor, the minimum rock height allowed, the daily water consumption, the limestone rock-CO₂ reactivity, the free CO₂, the total aggressive CO₂ desired, the bulk density of the limestone rock, etc.

As stated above, the user can choose the quantity of minerals desired in the remineralized water by means of a control screen of the D-AWG of the invention connected to the microcontroller. One of the following parameters can be selected and set: calcium concentration, magnesium concentration, conductivity, alkalinity, hardness.

According to the parameters defined by the user, the microcontroller adapts the concentration and the flow rate of the CO₂ to inject, based on the quantity of CaCO₃ and MgCO₃ which constitute the rock contained in remineralization reactor 15. The microcontroller also calculates the water flow rate for the required contact time between the aggressive CO₂ and the limestone rock and readjusts the proportional solenoid valve referenced 2 with flow meter 3.

A sediments particle filter 16 or a microfiltration membrane can be placed at the outlet of remineralization reactor 15, to filter possible fines and/or microorganisms released at the outlet of reactor 15. The lifetime of the filter can then be calculated with flow meter 3 or flow meter 21 located downstream of remineralization reactor 15.

It is in fact optionally possible to arrange a conductometer 19 and a pH meter 20 connected to the microcontroller in the piping upstream of a storage tank referenced 23 or in this tank. They allow monitoring the proper progress of the remineralization. In case of an anomaly, the user is alerted via the display screen.

A UV-C sterilization reactor 17 is placed downstream of remineralization reactor 15 and it is activated when the water circulates, to disinfect the water coming from reactor 15.

A tank 23 having a shape close to a straight circular cylinder is used to store the produced water before it is consumed. The bottom has a conical or semi-spherical shape to allow complete draining. The walls are smooth.

The quantity of water in storage tank 23 is calculated thanks to two flow meters/water meters referenced 21 and 26 located upstream and downstream of the tank. As a variant, a membrane sensor located at the outlet of storage tank 23 calculates the water volume thanks to the pressure exerted by the water on the latter. In another variant, a simple float sensor measures the water level in storage tank 23.

An anti-particulate and/or antibacterial vent filter referenced 22 is placed on the top of storage tank 23 in order to filter the air that is in contact with the water, if the tank is not pressurized.

A UV-C lamp referenced 24 in its protective shell can be placed in tank 23. A dose of Ultra Violet energy is dispensed periodically (every hour in certain embodiments) to guarantee quality water. As an alternative, a UV-C reactor is placed after the tank to disinfect the water that is consumed or that circulates in the recirculation.

When the quantity of water in recovery tank 35 is at its minimum or the quantity of water in storage tank 23 is at its maximum, the remineralization process is interrupted: pump 38 stops water circulation, solenoid valve 1 closes and cuts the communications between the different networks, proportional solenoid valve 2 opens at the maximum to ensure a maximum flow rate in case of recirculation, proportional gas solenoid valve 8 closes and stops the injection of CO₂, UV-C lamp 16 stops radiating. The dissolution of the alkaline earth rock of the calcium carbonate and/or magnesium carbonate type stops as there is no longer enough aggressive CO₂ to continue the dissolution reaction and water reached the calco-carbonic equilibrium. Therefore, pH, alkalinity and hardness remain stable.

In another embodiment, the rock used for neutralization may also consist totally or partly of calcium/magnesium oxide (CaO/MgO).

In another embodiment, the neutralization on rock can be followed by or replaced with the injection of a chemical compound that allows achieving more easily the calco-carbonic equilibrium (i.e. carbonate saturation index higher than 0).

### 5.5 Water Circulation and Recirculation in the D-AWG

It must be noted that water treatment module 102 and remineralization module 103 have each their recirculation circuit. These recirculations are activated when the potable water production device is not in operation, i.e. has been stopped for a long time. The recirculation allows circulating periodically the water through the network and therefore preventing water stagnation, which furthers bacterial growth followed by the possible development of a biofilm. It also allows re-passing the water through the UV disinfection reactors in order to guarantee a biologically healthy water at any time. The use of two distinct recirculation circuits allows proposing a D-AWG with a cost-effective operation, that offers jointly a deionizing treatment on the one hand and a remineralizing treatment on the other hand.

The D-AWG of the invention has been described here according to a particular embodiment, wherein the water undergoes, on the one hand, a deionizing treatment and, on the other hand, a remineralizing treatment, each of these two treatments being implemented in a closed and distinct recirculation circuit. However, the invention primarily relates to an AWG that implements a water remineralizing treatment, independently of the implementation of a deionizing treatment or of the use of two distinct recirculation circuits. The atmospheric water generation device of the invention also could implement a water deionizing treatment without implementing a remineralizing treatment as described above, and whatever the structure of the water circulation circuit(s).

The atmospheric water generation device of the invention also could implement a water filtering treatment (with a particle filter and/or a ultrafiltration membrane and/or an activated carbon filter), without implementing a deionizing treatment or a remineralizing treatment as described above, or a water filtering treatment implementing also only a deionizing treatment, without remineralization, or a water filtering treatment implementing also only a remineralization treatment, without deionizing, or, as described above, a water filtering treatment implementing also a deionizing treatment and a remineralizing treatment. The atmospheric water generation device of the invention also can implement a partial or total oxidation of the chemical compounds present in the water (condensed and/or filtered and/or deionized and/or remineralized). This chemical oxidation can be achieved by chlorination, by the action of chlorine dioxide, by the action of ozone, by ultraviolet radiation, preferably with a wavelength equal to or of the order of 185 nm or also by implementing an AOP-type process. The atmospheric water generation device of the invention also can implement a water disinfection (condensed and/or filtered and/or deionized and/or remineralized) by means of a ultraviolet lamp, chlorine, chlorine dioxide or ozone. Such disinfection can use a residual disinfectant to ensure in time water quality at microbiological level during the distribution of this water in a piping network. Disinfection and oxidation can be performed jointly during a same step. The recirculation device presented above is advantageously used in the domestic D-AWGs, which only produce small quantities of potable water per day. For industrial D-AWGs, which produce large quantities of water, the water is directly used continuously. Recirculation is then not necessary. Solenoid valves 1 and 28, and piping paths C and D, are not implemented. In a particular embodiment, storage tank 23 and distribution pump 25 are not implemented either. The D-AWG stops at the end of path B. The UV lamp referenced 17 can also be replaced with a module that allows injecting a residual disinfectant.

### 5.6 Second Embodiment

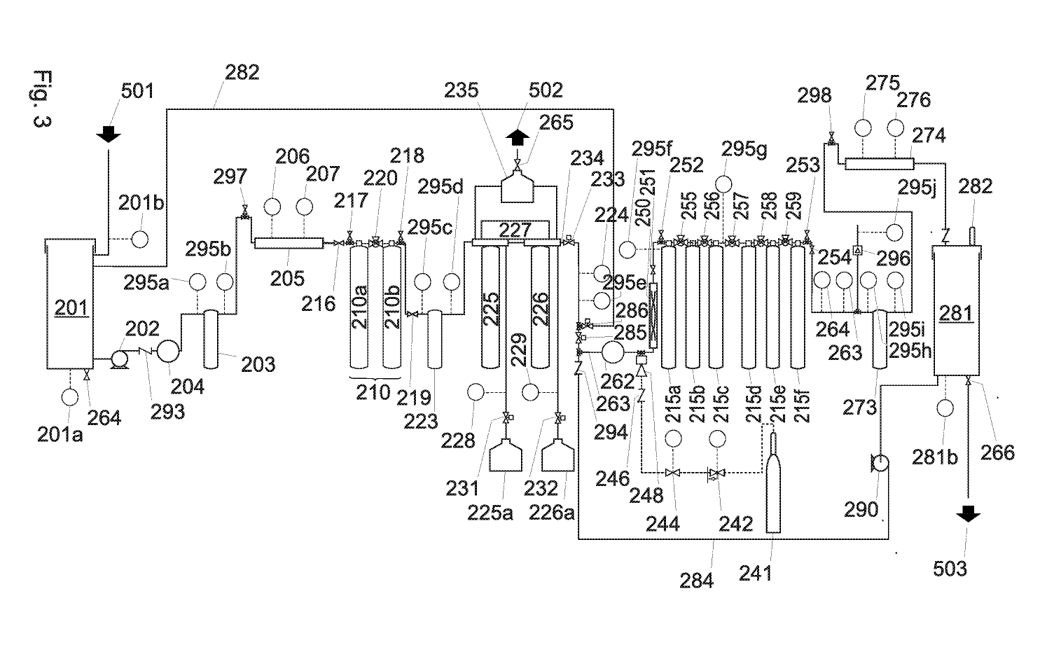

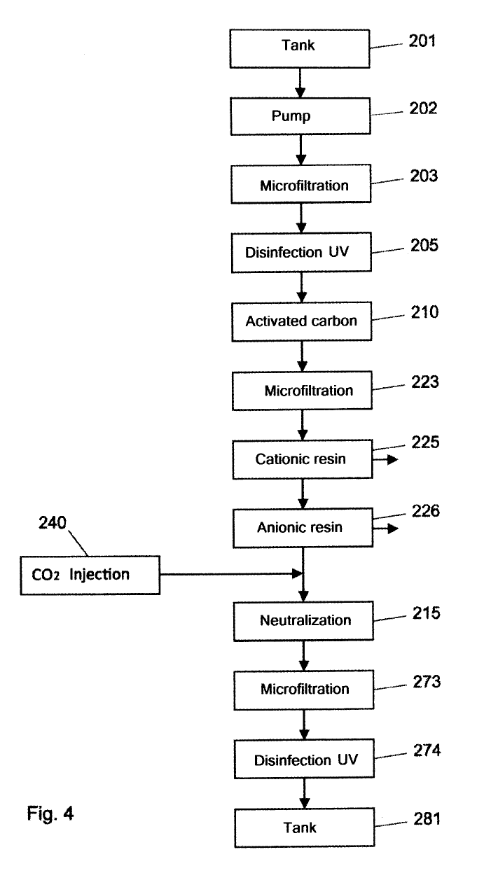

The continuation of the description describes a water treatment device according to a second embodiment of the invention, referring to FIG. 3, and the corresponding water treatment method, referring to FIG. 4.

The device of FIG. 3 proposes an implementation of the water treatment at least by microfiltration, followed by a deionization on ion exchange resins, followed itself by a remineralization.

The control screen allows the user to switch quickly between three manual operating modes. The “treatment” mode, which starts the water treatment, the “regeneration” mode, which starts the regeneration of the ion exchange resins contained in reactors 225 and 226 (as described below), and the “recirculation” mode, which allows the double circulation of the water, whose flow is separated between a first section of the device performing the deionizing treatment and a second section of the device performing the remineralization treatment. There is also an “automatic” mode, which allows the microcontroller to alternate automatically between these three modes according to the needs.

At the inlet of the device of FIG. 3, flow 501 of condensed water is collected in the first recovery tank (201 on FIG. 3), is pumped by pump 202 and sent through one (or several) first microfiltration stage(s) 203 to remove the particles from the condensed water. The maximum size of the particles retained by this first microfiltration stage is preferably comprised between 0.1 μm and 20 μm. The treatment flow of pump 202 can be variable and is regulated by a flow sensor 204.

The water then passes through a first Ultra-Violet disinfection reactor 205 operating at a disinfecting wavelength of 254 nm and delivering a dose of at least 120 mJ/cm2. This pre-treatment disinfection in reactor 205 allows not to contaminate the section of the treatment system located downstream of reactor 205. The first disinfection reactor 205 is monitored by a first UV intensity sensor 206 and a temperature sensor 207 mounted on disinfection reactor 205.

The water then passes through an activated carbon filtration module 210. According to the dimensions, this activated carbon filtration module 210 can be made of one or several filters (the two filters 201a and 201b on FIG. 3). These filters can be maintained by manual co-current or counter-current cleaning thanks to valves (216 to 220). The activated carbon is used for eliminating pesticides and other organic chemicals, the taste, the smells and the total organic carbon (TOC). The dimensioning allows a contact time suitable for the filtering of the VOCs (volatile organic compounds).

In a specific variant, a ultrafiltration membrane (not represented) is placed before activated carbon filtration module 210.

A second microfiltration stage 223 can be placed optionally downstream to avoid releasing activated carbon fines in the network.

In addition to this filtering, the water must be subjected to ionic filtration in order to remove the pollutants in ionic form such as unwanted ions (ammonium (NH₄⁺), nitrite (NO₂⁻), nitrate (NO₃⁻), etc.), trace metals and possibly radionuclides. A strongly acid cation exchange resin (SAC) unit 225 is used, followed by a strongly basic anion exchange resin (SBA) unit 226. These resins also allow removing the CO₂ from the water. A conductivity sensor 224 allows monitoring the good progress of the process. Once saturated the resins are regenerated.

In the embodiment presented in FIGS. 3 and 4, the various regeneration steps of the two ion exchange units 225 and 226 are controlled automatically by a control system with a camshaft 227 that operates with pneumatic energy and is connected to three pressure switches. During the regeneration mode, the pump switches from a flow rate control to a pressure control and sends 3 or 5 bar. Pump 202 adjusts its pressure with pressure sensor 295d. The duration of the various steps (counter washing, suction, slow motion, fast cleaning) is defined on the interface of control system 227. The acid and the base necessary for the respective regeneration of the cationic and anionic resins are drawn by a system with a venturi from the acid 225a and base 226a tanks. The drawing flow rates are displayed on two rotameters 228 and 229. Pressure switches connected to control system 227 and to the microcontroller control the opening or the closing of solenoid valves 231 to 233, thus allowing respectively drawing the acid, drawing the base and closing treatment way 234 during regeneration. The washing waters and brines produced during the various regeneration steps, which have acid and basic pHs, are forwarded to a recovery tank 235 to neutralize each other when they are mixed. The brine 502 obtained by this mixing in recovery tank 235 has a neutrality that allows disposing of it in the sewer through valve 265. The water deionized with this automated regeneration type according to such device has an electrical conductivity close to 0.5 μS/cm at 25° C.

In another not represented embodiment, the two ion exchange units 225 and 226 are replaced with an electrical deionization technology (electrodeionisation (EDI), electrodialysis (EDR), capacitive deionization (CDI), membrane capacitive deionization (M-CDI)). This advantageously allows reducing the quantity of water lost during the regenerations and also reducing the environmental impact.

The water, which is now purified (by microfiltration, activated carbon filtration followed by deionization) now needs to be remineralized. The remineralization of this device is based on a recarbonation by injection of carbon dioxide (injection module 240 in FIG. 4) and a neutralization by filtration on a calcium carbonate (CaCO₃) alkaline earth rock mixed with magnesium carbonate (MgCO₃) in a remineralization reactor 215 (see FIG. 4). The calcium/magnesium carbonates react with the free aggressive CO₂ of the water, which leads to a simultaneous increase of the hardness and of the alkalinity. Thus, filtration on limestone allows neutralizing the water, but also remineralizing it partially. By increasing the CO₂ concentration of the condensed water, filtration allows a more significant increase of the alkalinity and therefore allows a real remineralization of the water. Therefore, remineralization reactor 215 allows performing a neutralization by filtration on alkaline earth rock.

In injection module 240, food-grade gaseous CO₂ is sent under pressure in the water. The pressure of the CO₂ supplied by a bottle under pressure 241 is adjusted by means of a pressure regulator 242 of the pressure gage type. For a proper injection the CO₂ must have a pressure at least 1 bar higher than the water. A mass flow rate controller 244 made of a proportional solenoid valve and of a sensor allows delivering the desired CO₂ flow rate. The CO₂ then passes through a check valve 246 before it is injected in the water by injection nozzle 248. The dissolution of the gaseous CO₂ in the water is facilitated by an in-line static mixer 250. The water then passes through the alkaline earth rock of remineralization reactor 215. According to the dimension, this remineralization reactor 215 can be made of one or several tanks arranged serially (215a to 215f). These filters can be maintained by co-current or counter-current cleaning thanks to valves 251 to 259. The pH and the conductivity of the remineralized water are checked by a pH meter 263 and a conductometer 264. According to the desired CO₂ concentration in the water, the automatic control regulates mass flow rate controller 244 in function of the water flow rate measured by flow meter 262 or 204. The water flow rate and the CO₂ concentration are set by the user via the microcontroller interface in order to obtain the desired quantity of ions.

The water then passes through a particle filter that forms a third microfiltration stage 273 to remove possible particles, such as calcite fines, and therefore prevent them from contaminating the continuation of the network.

A second UV-C Ultra-Violet disinfection reactor 274 completes this treatment by applying a 40 mJ/cm² dose to make this water totally potable. The disinfection system is monitored by a second UV intensity sensor 275 and a second temperature sensor 276 mounted on second Ultra-Violet disinfection reactor 274. The advantage of the ultraviolet radiation treatment, in contrast to all residual chemical disinfectants, is that it produces no disinfection by-products. This is an advantage if the water is consumed quickly after treatment or bottled.

The water is then stored in a second tank 281 open to the atmosphere via an antibacterial air filter 282.

In order to avoid bacterial growth furthered by stagnant water, a periodic water circulation (recirculation) system is preferably implemented in the whole water network. The recirculation also allows passing the water again through the germicide UV lamps in order to keep the water exempt from microorganisms. This system allows stopping the treatment for a long period of time without contamination risk, for example in the case of an unfavorable condensation period. In this case, the recirculation is divided into two distinct circulation sections that can be operated jointly in a cost-effective manner: the recirculation of the deionized water (as in paths A and C of FIG. 2) and the recirculation of the remineralized water (as in paths B, G and D of FIG. 2) Solenoid valves 285 and 286 allow separating the treatment of the condensed water into potable water (Treatment Mode) from the double recirculation cycle (Recirculation Mode). During Recirculation Mode, pump 202 circulates the water in the deionized water recirculation circuit: through the purification treatment towards way 234, then deionized water recirculation piping 282 towards tank 201 thanks to solenoid valves 285 and 286. Pump 290 circulates the water in the remineralized water recirculation circuit: through remineralized water recirculation piping 263 then the remineralization devices up to tank 281. The flow rate of pump 290 is monitored by flow meter 262. Pumps 202 and 290 are protected by check valves 293 and 294. Check valve 294 also allows preventing the water from entering directly tank 281 via pump 290 during the manual “treatment” mode.

In an embodiment, the UV-C Ultra-Violet disinfection reactor 274 or an additional UV-C Ultra-Violet reactor is arranged downstream of storage tank 281 to perform a final disinfection of the water just before its distribution.

Pressure sensors 295a to 295j are arranged upstream and downstream of the various following filtration modules: microfiltration stages 203,223 and 273; activated carbon filter 210, ion exchange resin units 225/226; CO₂ injection nozzle 248, remineralization reactors 215, and safety valve 296, in order to monitor the pressures and the pressure losses. The automatic control stops the actuators in case of an abnormally high pressure. An additional physical safety is added with a safety valve 296.

The volumes of the first and second tank 201 and 281 are measured thanks to first and second pressure sensors 201a and 281a.

A conductivity and a pH sensor 201b can be arranged upstream of first tank 201 to monitor the characteristics of the condensed water.

Valves 297 and 298 can be added to sample water or purge the air from the piping.

Valves 264 to 266 are used to drain tanks 201, 235 and 281.

The potable water 503 is distributed by gravity through valve 281 or by pump 290 and a (non identified) solenoid valve.

So, in this second embodiment, one uses, from upstream to downstream, at least the following condensed water treatment elements: microfiltration means (microfiltration step(s) 203, 223), deionizing means using ion exchange resins (cationic resin unit 225, anionic resin unit 226) and means for adding minerals (remineralization reactor 215, CO₂ injection module 240). According to a preferred variant, activated carbon filtration means (210) are used. These filtration means preferably comprise an activated carbon filtration module (210) placed between said microfiltration means and said deionizing means using ion exchange resins.

### 5.7 Further Embodiments

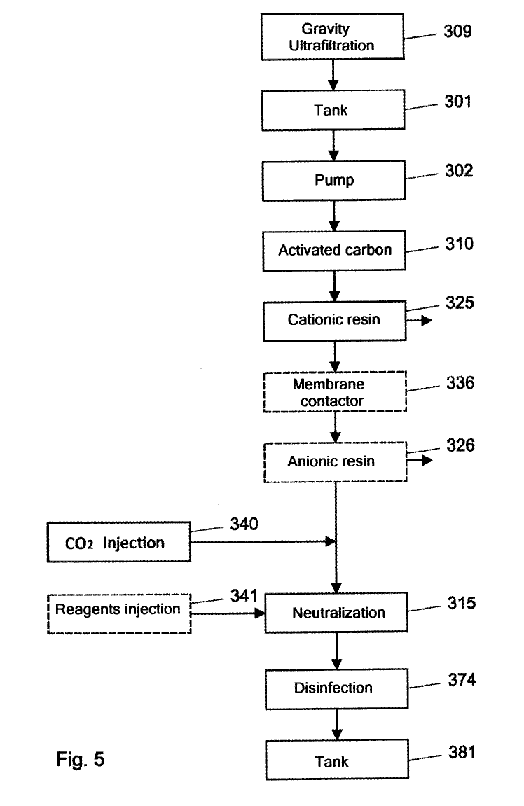

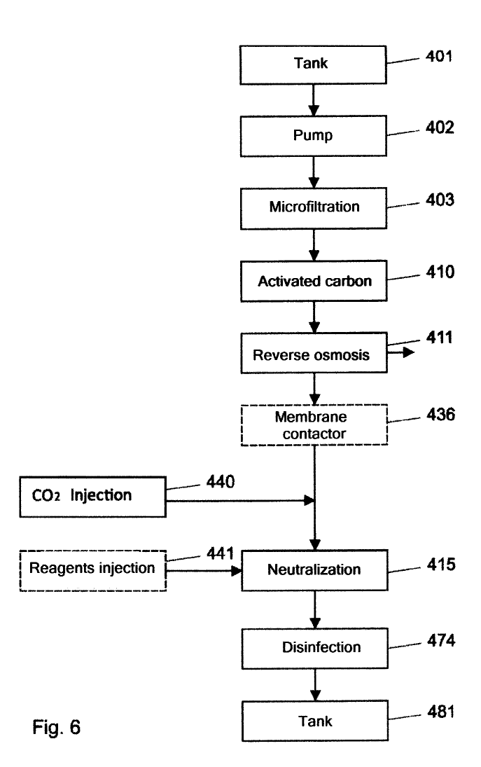

The continuation of the description will describe other possible embodiments of the water treatment method of the invention, referring to FIGS. 5 and 6.

FIG. 5 represents schematically the treatment elements/steps of a condensed water treatment method according to a third embodiment, using an ultrafiltration system. Such ultrafiltration system can have a cut-off threshold (“Molecular Weight Cut-Off”) reaching 10,000 Dalton.

The method of FIG. 5 proposes an implementation of the water treatment at least by ultrafiltration, followed by a deionization on ion exchange resins, followed itself by a remineralization.

In this third embodiment, a gravity ultrafiltration membrane (gravity ultrafiltration stage 309) is used for the first step of the treatment. The condensed water is forwarded into a gravity ultrafiltration membrane. This type of membrane has the advantage that it uses no energy, as the water flows by gravity through the walls. The goal is to remove a maximum of organic compounds from the water and to perform a primary disinfection.

The water is then recovered in a recovery tank 301, is then pumped by pump 302 and then delivered to an activated carbon filtration module 310 containing granular activated carbon (GAC) through which the water flows.

In a non represented variant, a classical ultrafiltration located after pump 302 is used. A particle filtration (microfiltration, cartridge, sand) can precede this ultrafiltration treatment to filter a part of the coarse particles and thus reduce the maintenance steps of the ultrafiltration. Depending on the quality of the condensed water, a UV disinfection system (not represented) can also be used upstream of the ultrafiltration to reduce the maintenance of the membrane.

Downstream of the activated carbon filtration module 310, the water then passes in one or several units with ion exchange resins composed of ions that allow removing a part or all of the ions present in the water (ionic water filtration). A strongly acid cations exchange resin (SAC) unit 325 is used to that purpose. In a variant, the treatment in the strongly acid cations exchange resin tank 325 is followed by a treatment in another ion exchange resin unit containing a strongly basic anion exchange resin (SBA) 326. If a strongly basic cationic resin with H⁺ protons exchange is used, CO₂ will be formed between the HCO₃⁻ of the water and the H⁺ released by the cationic resin. In order to save the strongly basic anionic resin, a CO₂ removal process can be used between the two ion exchange resin units 325 and 326.

For example, a membrane contactor 336, located between the two ion exchange resin units 325 and 326, can be used to remove certain gases such as the CO₂ or possible remaining VOCs from the water.

The water is then remineralized as in the second embodiment described previously in reference to FIG. 4, by injection of CO₂ (CO₂ injection module 340) and a neutralization on calcium and magnesium carbonate rock (neutralization in a remineralization reactor 315) in order to add the following ions in the water: Ca²⁺, Mg²⁺, HCO₃⁻.

According to the type of application, it is moreover optionally possible to add other minerals or to change the carbonate saturation index by injecting (reagents injection module 341) or using one or several reagent(s) complementary to the neutralization.

The injection of these reagents can take place before, during or after the neutralization of the CO₂ on the alkaline earth rock (FIG. 5 shows the case of a reagents injection in remineralization reactor 315, thus during the neutralization). This injection can be performed by one or several dosing pumps.

Depending on the embodiment or on the dimensioning, the water produced after the neutralization of the injected CO₂ on a carbonate rock may not reach the CaCO₃ saturation equilibrium required for sending the water in the piping network. In this case an additional reagent can be injected in the form of a solution to reach the calco-carbonic equilibrium. We can for example mention the use of caustic soda (NaOH), sodium carbonate (Na₂CO₃), sodium bicarbonate (NaHCO3) or quick lime/calcium oxide (CaO).

The addition of CO₂ and the neutralization on calcium/magnesium carbonate will produce a water containing Ca²⁺, Mg²⁺, HCO₃⁻. Other reagents can be used to change the proportion of these minerals or to add complementary minerals (Cl−, Na+, SO₄²⁻, K+, etc.), as for example: sodium hydroxide/caustic soda (NaOH), sodium carbonate (Na₂CO₃), sodium bicarbonate (NaHCO₃), quick lime/calcium oxide (CaO), slaked lime/calcium hydroxide (Ca(OH)₂), calcium chloride (CaCl₂), magnesia dolomite (CaCO₃+MgO), magnesium hydroxide-oxide (Mg(OH)₂-MgO), calcium sulphate (CaSO₄), sodium chloride (NaCl), sulphuric acid (H₂SO₄), hydrochloric acid (HCl), potassium chloride (KCl).

In another embodiment, chemical inhibitors can also be added to prevent scaling or corrosion problems in the piping.

After the neutralization (downstream of remineralization reactor 315), the remineralized water is disinfected (disinfection reactor 374) before it is stored in a tank 381 or sent directly to a point of use (for example bottling, supply piping, et.). In a particular embodiment, disinfection step 374 or a new disinfection step can be performed after tank 381.

Depending on the type of application, the water can be disinfected using various disinfection techniques: by ultraviolet (UV) radiation, chlorine, chlorine dioxide, ozonation, etc.

Depending on the method chosen, this disinfection step can also serve as an oxidation step.

A specific embodiment is given as an example, using a weakly acid cation exchange resin (WAC) and a chlorination used as a disinfection and oxidation technique. The water exiting from the activated carbon filtration module 310 is sent in a tank 325 containing weakly acid ion exchange resin (WAC) to remove certain unwanted cations such as ammonium from the water. Removing the ammonium that can occur at high concentrations in the condensed water will avoid the production of chloramine during chlorination, which has less efficient disinfection properties than chlorine (critical point). The water is then remineralized (remineralization reactor 315) and chlorinated (disinfection reactor 374). In this embodiment, chlorination has also the objective of oxidizing certain compounds. Chlorine will oxidize unwanted compounds such as NO₂⁻ into NO₃⁻. According the embodiment, the chlorine can be produced on site by electrolysis of brine. An electrochemical sensor will monitor the free chlorine concentration in the water.

The water is then stored in a tank 481 or sent directly to a point of use (for example bottling, supply piping, etc.). In a particular embodiment, disinfection step 474 or a new disinfection step can be performed after tank 481.

In an embodiment variant, the ion exchange resins are replaced with an electrochemical deionization technology, as mentioned previously in reference to FIGS. 3 and 4.

So, in this other and third embodiment of the method according to the invention, a condensed water treatment device according to a third embodiment is used, which comprises, from upstream to downstream, at least the following condensed water treatment elements: gravity ultrafiltration means (309), deionizing means with ion exchange resins (cationic resin unit 325 and optionally anionic resin unit 326) and means for adding minerals (remineralization reactor 315, CO₂ injection module 340). According to a preferred variant, an activated carbon filtration module (310) is placed between said gravity ultrafiltration means and said deionizing means using ion exchange resins.

FIG. 6 represents schematically the treatment elements/steps of a method according to a fourth embodiment, using a reverse osmosis system. Such reverse osmosis system can have a cut-off threshold (“Molecular Weight Cut-Off”) reaching 100 (or even 50) Dalton.

The method of FIG. 6 proposes an implementation of the water treatment at least by microfiltration, followed by a reverse osmosis, followed itself by a remineralization.

In this fourth embodiment, the condensed water collected in recovery tank 401 is pumped by pump 402, this water is then sent through one (or several) first microfiltration stage(s) 403 (for example a particle filtration by means of a microfiltration membrane, a cartridge, sand). In a specific embodiment, one of the microfiltration stages is made of at least one ultrafiltration module. This means in practice that microfiltration module 403 can be made of only one (or several) microfiltration stage(s), or simultaneously of one (or several) microfiltration stage(s) and one (or several) ultrafiltration stage(s), or of only one (or several) ultrafiltration stage(s).

The water then passes through a granular activated carbon filtration module 410. The activated carbon filtration module 410 can be used either as a pre-filtration for a reverse osmosis step (case represented on FIG. 6) or as a downstream treatment of a reverse osmosis step (refining), or both.

The water then passes through a filtration unit using a reverse osmosis membrane 411. This filtration can be performed by one or several reverse osmosis membranes arranged serially, said membranes being similar/identical or different (specific). This reverse osmosis step has a double role: deionize the water and thus remove the unwanted ions from the water, but also remove the dissolved organic pollutants up to 50 Dalton from the water. Depending on the quality of the condensed water to be treated, a UV disinfection system (not represented) can be used upstream of reverse osmosis membrane filtration unit 411 to reduce the maintenance of the membrane.

Reverse osmosis does not remove the CO₂ or certain gases that are below its filtration threshold, such as certain organic compounds, from the water. In an embodiment variant, a membrane contactor 436, placed downstream of reverse osmosis membrane filtration unit 411, can be used to remove a part of these gases from the water. The advantage of removing the CO₂ is to be able to perform a totally controlled demineralization, without being dependent on the CO₂ variations of the condensed water.

The end of the treatment is similar to the device/method presented for the ultrafiltration treatment in connection with FIG. 5: this is a water remineralization step with injection of CO₂ (CO₂ injection module 440) and neutralization on calcite (neutralization in a remineralization reactor 415) followed by a disinfection (disinfection reactor 474). The choice of the disinfection device can vary according to the use of the produced water (ultraviolet, chlorination, chlorine dioxide, ozone, etc.).

In an embodiment variant, reagents can be injected in the water through a reagents injection module 441, to extend the possibilities of remineralization as in the case of the third embodiment previously described in connection with FIG. 5.

So, in this other and fourth embodiment of the method according to the invention, a condensed water treatment device according to a fourth embodiment is used, which includes, from upstream to downstream, at least the following condensed water treatment elements: microfiltration means (microfiltration stage 403), reverse osmosis treatment means (filtration unit with reverse osmosis membrane 411) and means for adding minerals (remineralization reactor 415, CO₂ injection module 440)

The various embodiments of the device and of the method for treating condensed water according to the invention presented in the previous description can be intended for several applications.

Additional devices can be added upstream or downstream of the device according to the invention or upstream or downstream of one of the treatments forming the device according to the invention to facilitate the connection of the device according to the invention. An example is the recovery of the water condensed by an air conditioning system of a building in order to bottle the potable water produced. The water condensed by the various air handling units (AHU) of an air conditioning system is centralized through a piping or draining network and forwarded by gravity to a pipe flowing into a pit or a buffer tank. A pre-filtration stage is arranged upstream of the pit or buffer tank to recover, for example, by gravity, large particles in order to avoid clogging the particle (203, 403) and membrane (309, 411) filters of said water treatment devices and methods. This particle pre-filtration stage can for example be made of a pre-filter basket and a bag filter. The condensed water stored in the tank is then sent to the water treatment tank (201, 301 or 401) through a pump connected to the automatic control of the treatment device according to the invention.

In a particular embodiment, the buffer tank can replace the tank (201, 301 or 401), in particular in the device comprising a gravity ultrafiltration module (309).

In this example, a bottling unit is mounted downstream of said treatment device/method according to the invention.

1-36. (Canceled)

37. A device for treating water condensed from water vapor contained in the air,
wherein the device comprises means for adding minerals to the condensed water by contact of the condensed water with a remineralization reactor containing at least one alkaline earth rock,
the means for adding minerals further comprising:
means for controlling a contact time of the condensed water with the remineralization reactor;
means for calculating a quantity of carbon dioxide to be injected in the condensed water, allowing dissolution of the alkaline earth rock in order to obtain in the water a predetermined quantity of minerals to be added;
injecting means able to inject the quantity of carbon dioxide, calculated by the calculation means, in the condensed water; and
the means for adding minerals being able to produce a remineralized water.

38. The device according to claim 37, wherein the control means are able to control at least one of the following parameters:
a flow rate of the condensed water in the remineralization reactor;
a concentration of the carbon dioxide to be injected;
an injection flow rate of the carbon dioxide; and
a pressure of the carbon dioxide to be injected.

39. The device according to claim 37, wherein the device further comprises means for a user to select the predetermined quantity of minerals to be added to the condensed water.

40. The device according to claim 37, wherein the device further comprises means for deionizing the condensed water for producing deionized water.

41. The device according to claim 40, wherein the means for deionizing the condensed water comprise at least one element selected from the group consisting of:
an ion exchange resin module;
an aluminosilicate rock of a Zeolite type;
electrical and/or electrochemical deionizing means such as electrodeionization (EDI), electrodialysis (EDR), capacitive deionization (CDI), membrane capacitive deionization (M-CDI);
a reverse osmosis membrane; and
a nanofiltration membrane.

42. The device according to claim 37, wherein the device also comprises means for filtering the condensed water and/or the deionized water and producing filtered water, using at least one element selected from the group consisting of:
a particle filter;
an activated carbon filter;
an ultrafiltration membrane; and
a membrane contactor or a gaseous filtration membrane.

43. The device according to claim 40, wherein the means for adding minerals is arranged downstream of the deionizing means so that the minerals are added to the deionized water in order to produce the remineralized water.

44. The device according to claim 37, wherein the device further comprises a degassing system able to remove at least one Volatile Organic Compound (VOC), unwanted gas or CO₂ from the water.

45. The device according to claim 40, wherein the device comprises two dissociated water circulation circuits:
a first water circulation circuit comprising a tank for recovering the condensed water, the deionizing means for the condensed water and first water disinfection means;
a second water circulation circuit comprising the means for adding minerals, a tank for storing the remineralized water and second disinfection means for the remineralized water.

46. The device according to claim 45, wherein the device comprises means for the periodic activation of the circulation of the water in each of the first and second water circulation circuits.

47. The device according to claim 37, wherein the further comprises means for partial or total oxidation of at least one chemical compound present in the condensed water, in the filtered water, in the deionized water or in the remineralized water.

48. The device according to claim 47, wherein the means for partial or total oxidation means is selected form the group consisting of:
chlorination oxidation means;
means for oxidation by action of chlorine dioxide;
means for oxidation by action of ozone;
means for oxidation by ultraviolet radiation; or
means for implementing an advanced oxidation process (AOP).

49. The device according to claim 37, wherein the further comprises means for disinfecting at least one of the condensed water, the filtered water, the deionized water or the remineralized water, implementing at least one of element selected from the group consisting of:
an ultraviolet lamp;
chlorine;
chlorine dioxide; or
ozone.

50. The device according to claim 47, wherein the disinfection means comprise at least one residual disinfectant.

51. The device according to claim 37, wherein the device further comprises means for adding one or more reagents selected from the group consisting of: sodium hydroxide/caustic soda (NaOH), sodium carbonate (Na₂CO₃), sodium bicarbonate (NaHCO₃), quick lime/calcium oxide (CaO), slaked lime/calcium hydroxide (Ca(OH)₂), calcium chloride (CaCl₂), magnesia dolomite (CaCO₃+MgO), magnesium hydroxide-oxide (Mg(OH)₂-MgO), calcium sulphate (CaSO₄), sodium chloride (NaCl), sulphuric acid (H₂SO₄), hydrochloric acid (HCl), potassium chloride (KCl).

52. The device according to claim 37, wherein the device comprises, from upstream to downstream, at least microfiltration means (203, 223), deionizing means using ion exchange resins (225, 226) and the means for adding minerals (215, 240).

53. The device according to claim 52, wherein the device further comprises activated carbon filtration means (210) placed between the microfiltration means and the deionizing means using ion exchange resins (225, 226).

54. The device according to claim 37, wherein the device further comprises, from upstream to downstream, at least ultrafiltration means (309), deionizing means (325, 326) and the means for adding minerals (315, 340, 341).

55. The device according to claim 54, wherein the ultrafiltration means are gravity-driven membranes (309).

56. The device according to claim 54, wherein the deionizing means are deionizing means using ion exchange resins (325, 326) or deionizing means using an electrodeionization or reverse osmosis deionizing means.

57. The device according to claim 54, wherein the device further comprises activated carbon filtration means (310) placed between the ultrafiltration means and the deionizing means.

58. The device according to claim 37, wherein the device further comprises, from upstream to downstream, at least microfiltration means (403), a reverse osmosis treatment means (411) and the means for adding minerals (400, 441, 415).

59. The device according to claim 58, wherein the device further comprises activated carbon filtration means (410) which is located downstream of the microfiltration means (403).

60. The device according to claim 59, wherein the activated carbon filtration means (410) are located upstream of the reverse osmosis treatment means (411).

61. The device according to claim 59, wherein the activated carbon filtration means (410) are located downstream of the reverse osmosis treatment means (411).

62. The device according to claim 52, wherein the device further comprises oxidation means which is located downstream of the means for adding minerals.

63. The device according to claim 52, wherein the device further comprises disinfection means which is located downstream of the means for adding minerals.

64. A system for generating potable water from atmospheric air, comprising means for condensing water vapor contained in the air, able to produce condensed water, wherein the system comprises a treatment device for the condensed water according to claim 37.

65. The system according to claim 64, wherein the device further comprises means for treating the atmospheric air arranged upstream of the condensation means.

66. The system according to claim 64, wherein the device further comprises at least one sensor delivering an information about the quality of the atmospheric air, and means for stopping the potable water generation system able to stop the potable water generation system when the information about a quality of the air is lower than a predetermined threshold.

67. The system according to claim 64, wherein the means for condensing water vapor contained in the air are part of an air conditioning device of a whole or of a part of a building.

68. The system for generating potable water from atmospheric air according to claim 64, wherein the means for condensing a water vapor contained in the air can be condensation means of human or natural origin.

69. The system for the generation of potable water from atmospheric air according to claim 64, wherein the system is located upstream of a bottling unit or of a potable water distribution network.

70. A method for treating water condensed from water vapor contained in the air,
wherein the method comprising adding minerals to the condensed water by contact of the condensed water within a remineralization reactor containing at least one alkaline earth rock,
and, while adding minerals, further implementing:
calculation of a quantity of carbon dioxide to be injected in the condensed water, according to a predetermined quantity of minerals to be added;
injecting the calculated quantity of carbon dioxide in the condensed water; and
controlling the contact time of the condensed water within the remineralization reactor,
to produce the remineralized water.

71. The treatment method according to claim 70, wherein the step of adding minerals further includes calculating a minimum contact time between the condensed water and the remineralization reactor according to the predetermined quantity of minerals to be added.

72. The method for generating potable water from atmospheric air, comprising condensing water vapor contained in the air, able to produce condensed water, and implementing a treatment method for the condensed water according to claim 70.
